(19) United States
(12) Patent Application Publication
(10) Pub. No.: US 2009/0327195 A1
(43) Pub. Date: Dec. 31, 2009

(54) ROOT CAUSE ANALYSIS OPTIMIZATION

(75) Inventor: Ahmet Salih Iscen, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/261,130

(22) Filed: Oct. 30, 2008

Related U.S. Application Data
(60) Provisional application No. 61/076,459, filed on Jun. 27, 2008.

(51) Int. Cl. G06N 5/04; G06N 5/02

(52) U.S. Cl. 706/47; 706/50

(57) ABSTRACT

Root cause analysis is augmented by providing optimized inputs to root cause analysis systems or the like. Such optimized inputs can be generated from causality graphs by creating sub-graphs, finding and removing cycles, and reducing the complexity of the input. Optimization of inputs enables a root cause analysis system to reduce the number of iterative cycles that are required to execute probable cause analysis, among other things. In one instance, cycle removal eliminates perpetuation of errors throughout a system being analyzed.

### CROSS REFERENCE TO RELATED APPLICATIONS

This application claims the benefit of U.S. Provisional Application Ser. No. 61/076,459, filed Jun. 27, 2008, and entitled ROOT CAUSE ANALYSIS OPTIMIZATION, and is incorporated herein by reference.

### BACKGROUND

Root cause or probable cause analysis is a class of methods in the problem-solving field that identify root causes of problems or events. Generally, problems can be solved by eliminating the root causes of the problems, instead of addressing symptoms that are being continuously derived from the problem. Ideally, when the root cause has been addressed, the symptoms following the root cause will disappear. Traditional root cause analysis is performed in a systematic manner with conclusions and root causes supported by evidence and established causal relationships between the root cause(s) and problem(s). However, if there are multiple root causes or the system is complex, root cause analysis may not be able to identify the problem with a single iteration, making root cause analysis a continuous process for most problem solving systems.

Root cause analysis can be used to identify problems on large networks, and as such has to contend with problems related thereto. By way of example, root cause analysis can be utilized to facilitate management of enterprise computer networks. Where there is a big network scattered across several countries/continents with many services, databases, routers, bridges, etc., it may be difficult to diagnose problems, especially since it is unlikely that administrators are aware of all network dependencies. Here, root cause analysis can be employed to point administrators to a root cause of a problem rather than forcing an ad hoc method based on administrator knowledge, which usually focuses on symptoms.

Of course, root cause analysis is not limited to computer network management. Root cause problems can come in many forms. Other example domains include but are not limited to materials (e.g., if raw material is defective, a lack of raw material), equipment (e.g., improper equipment selection, maintenance issue, design flaw, placement in wrong location), environment (e.g., forces of nature), management (e.g., task not managed properly, issue not brought to management's attention), methods (e.g., lack of structure or procedure, failure to implement methods in practice), and management systems (e.g., inadequate training, poor recognition of a hazard).

Conventionally, causality or inference graphs are employed in root cause analysis to model fault propagation or causality throughout a system. A causality graph includes nodes that represent observation, and root causes. Further meta-nodes are included to model how the state of a root cause affects its children. Links between nodes establish a causality relationship such that the state of the child is dependent on the state of the parent. Reasoning algorithms can then be applied over inference graphs to identify root causes given observations or symptoms.

### SUMMARY OF INVENTION

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject application pertains to optimizing root cause analysis via augmentation of a causal dependency graph. More specifically, optimization is provided by decreasing the number of iterative cycles that a root cause analysis system is required to run by dividing causality graphs into sub-graphs that are easily manipulated by a root cause analysis system, identifying and eliminating cycles within the sub-graphs, and further optimizing the sub-graphs via reduction or simplification, for instance. As a result, propagation of problems and memory complexity are both reduced, eliminating unreasonable response times or root cause identification failure due to system constraints, for example. Furthermore and in accordance with an aspect of the disclosure, the amount of errors propagated throughout a system can be reduced by resolving cycles that are indicative thereof. Moreover, causality graphs can be optimized in a manner that returns orders of magnitude improvement in the scalability and performance of the inference algorithms that perform root cause analysis.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an optimized root cause system in accordance with an aspect of the disclosure.

FIG. 2 is a block diagram of a representative optimization component according to a disclosed aspect.

FIG. 3a is a graph expressing an inference between two events.

FIG. 3b is a graph of multiple sequential events.

FIG. 3c is a graph of a combination of events.

FIG. 4 is a graph illustrating a Markovian parents.

FIG. 5 is an exemplary causality graph with several root cause nodes.

FIG. 6 is an exemplary bipartite representation of the causality graph of FIG. 5 in accordance with a disclosed aspect.

FIG. 7 is an exemplary bipartite representation of the causality graph of FIG. 5 further optimized to remove unnecessary nodes.

FIG. 8 is an exemplary bipartite representation of the causality graph of FIG. 5 further optimized to remove unnecessary nodes and edges.

FIG. 9 is an exemplary bipartite representation of the causality graph of FIG. 5 optimized by graph disconnection.

FIG. 10 is an exemplary causality graph for use in explanation of Markovian processing in accordance with an aspect of the disclosure.

FIGS. 11a, 11b, and 11c are exemplary graphs demonstrating Markovian optimization on several nodes.

FIGS. 12a and 12b are exemplary graphs that illustrate a modeling granularity issue.

FIGS. 13a and 13b are exemplary graphs illustrating a modeling granularity issue and resolution.

FIGS. 14a and 14b are exemplary graphs depicting cycles and cycle resolution.

FIG. 15a is a exemplary inference graph including cycles

FIG. 15b illustrates an exemplary graph of a reduced strongly connected component.

FIG. 16a is an exemplary graph including cycles.

FIG. 16b-i are exemplary graphs illustrating optimization of start and end node paths of graph of FIG. 16a.

FIG. 17 is a flow chart diagram of a method of optimizing root cause analysis in accordance with an aspect of the disclosure.

FIG. 18 is a flow chart diagram of a method of optimizing a causality graph in accordance with a disclosed aspect.

FIG. 19 is a flow chart diagram of a causality graph optimization method according to an aspect of the disclosure.

FIG. 20 is flow chart diagram of a method of identifying weakly connected graph components in accordance with an aspect of the disclosure.

FIG. 21 is a schematic block diagram illustrating a suitable operating environment for aspects of the subject disclosure.

FIG. 22 is a schematic block diagram of a sample-computing environment.

### DETAILED DESCRIPTION

Systems and methods pertaining to optimizing root cause analysis are described in detail hereinafter. Historically, root cause analysis has a family of techniques that analyze a causality or inference graph, along with reasoning algorithms. However, simply providing an inference graph to a root cause engine can lead to unexpected wait times for a response due to the numerous iterations that the root cause system or engine must perform. Furthermore, problems can arise due to the complexity of modeling causal relationships between multiple entities or work from multiple authors, among other things. Therefore, it is advantageous to optimize a causality or inference graph to facilitate root cause analysis.

In accordance with one aspect of the claimed subject matter, a causality graph can be divided into multiple sub-graphs to enable parallel processing of portions of the graph. According to another aspect, causality graphs can be reduced or simplified to facilitate processing. Furthermore, cycles within a graph can be identified and resolved to eliminate error propagation throughout the system.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

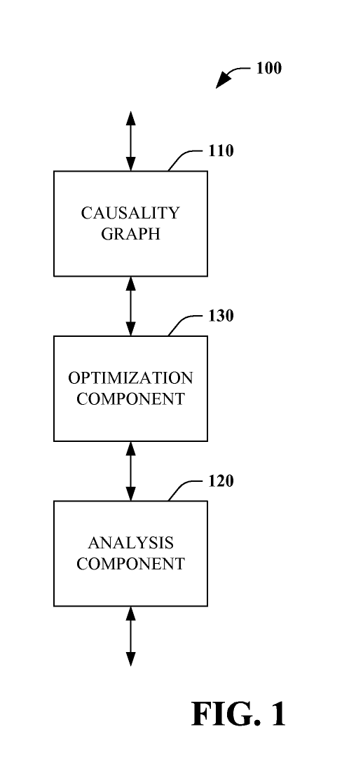

Referring initially to FIG. 1, an optimize root cause analysis system or engine 100 is illustrated in accordance with an aspect of the claimed subject matter. The system 100 includes a causality graph component 110 (also referred to herein as causality graph, inference graph, or inference graph component) that is a unified representation of causal dependencies amongst a network, for example. As will be appreciated further infra, one exemplary causality graph 110 can include a plurality of nodes of different types including root cause nodes, observation nodes, and meta-nodes that act as glue between the root cause and observation nodes. Edges interconnect the nodes and can include a dependency probability that represent the strength of dependency amongst connected nodes.

Analysis component 120 utilizes a causality graph to perform root cause analysis. In other words, the analysis component 120 can reason or perform inferences over the causality graph given some symptoms or observations. Various mechanisms can be utilized to provide such analysis. However, generally speaking, the analysis component 120 can try to find a hypothesis or cause that best explains all observations.

Optimization component 130 optimizes the causality graph 110 to facilitate processing by the analysis component 120. Causality graphs in general can become extremely large and complicated. In fact, root cause analysis is by nature utilized to deal with the large and complicated scenarios. For example, consider a worldwide computer network. Without help from a root cause analysis system, it can be extremely difficult if not impossible for an individual to identify the source of a problem rather than continually addressing symptoms. The extent and complexity of the problem space seemly requires the same of a solution. Conventionally, large-scale problem spaces necessitate generation of huge causality graphs, which result in performance issues. The optimization component 130 can produce an optimized version of the causality graph 110 of reduced size and complexity, among other things. As a consequence, orders of magnitude improvements can be achieved in terms of scalability and performance of processes, algorithms or the like that operate over causality graphs.

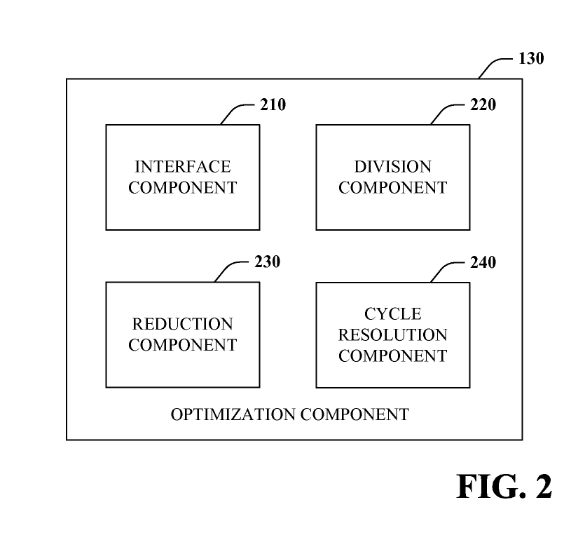

FIG. 2 depicts a representative optimization component 130 in accordance with an aspect of the claimed subject matter. The optimization component includes interface component 210, division component 220, reduction component 230, and cycle resolution component 230. The interface component 210 is a mechanism for receiving or retrieving a causality graph or the like and providing an optimized version thereof. Furthermore, the interface component 220 can enable retrieval and or receipt of additional information such as expert information to guide and/or further improve optimization.

The division component 220 can divide or break a causality graph into smaller sub-graphs. Analysis or reasoning algorithms perform much faster on sub-graphs rather than a causality graph as a whole. Reasoning is not only faster due to division of the graphs into simpler clusters. Multi-core or multiprocessor computer architectures can also be leveraged to enable sub-graphs to be processed in parallel by dedicated processors, for example. In other words, reasoning can be run on different machines for different sub-graphs so that machine capacity including physical memory and CPU capacity, amongst others are not bottlenecks. Further, reconfiguration of a causality graph can be improved. Since only a portion of the whole graph will need to be reconstructed when changes happen, reconfiguration is faster.

In accordance with one aspect, the division component 220 can break a causality graph into separate weakly connected sub-graphs. In one exemplary implementation, a depth first search can be utilized to loop through the graph and populate sub-graphs with weakly connected components. Edge weights can be calculated and edge reduction performed via catenation and/or combination operations, as will be described further infra.

Generally, enterprise environments, amongst others, produce causality graphs 110 that comprise unions of disconnected causality sub-graphs. Again, breaking up graphs into sub-graphs is advantageous because sub-graphs offer reduced complexity and faster processing times when being analyzed. The calculations below demonstrate a sample reduction in the number of iterations that would be required if a causality graph were not split into sub-graphs (e.g., 59049) versus the iterations required after processing into sub-graphs (e.g., 45). This illuminates starkly the amount of processing power and/or time saved utilizing the disconnected graph or splitting a causality graph into sub-graphs.

More specifically, for “s” states and “c” causes, the cardinality of assignment vector set is “s^{c}.” However, the number of assignment vectors in the set corresponds to “s_{c}>s_{c1}+s_{c2}+ . . . sₙ” for:

c₁+c₂+ . . . cₙ=c

c>1, s>1

c₁>0, c₂>0, . . . , cₙ>0

By way of example, given “s=3” and “c=10,” “s^{c}=59049.” However, for “c₁=3,” “c₂=3,” “c₃=4,” “s_{c1}+s_{c2}+s_{c3}=135.”

Determining disconnected or weakly connected graphs and breaking the causality graph into sub-graphs also creates more flexibility because root cause analysis reasoning algorithms can perform faster when run on individual sub-graphs rather than on an inference graph as a whole. These reasoning algorithms are faster because division component 220 divides graphs efficiently, and into organized clusters, where each cluster has a number of assignment vectors that is a manageable size. Another advantage that division component 220 provides by splitting an inference graph into smaller sub-graphs is the ability to perform root cause analysis on data sets that might otherwise exceed the capability of a root cause analysis system. For example, a root cause analysis system will probably have a finite physical memory, storage capacity, or central processing unit capacity. In the case where division is significant, not only will the root cause analysis take less time, the subject application could enable one to employ root cause analysis on systems that were previous unmanageable.

The reduction component 230 reduces causality graphs to their simplest state possible, which may include eliminating unnecessary edges and/or nodes from graphs. In accordance with one aspect, the reduction component 230 can reduce a graph to a bipartite graph including causes and symptoms or observations. Such a bipartite graph or otherwise reduced graph can then be used to perform root cause analysis in an efficient manner that saves time and processing power by providing a simplified set of information that retains all causality relationships from the input. According to one implementation, the reduction component 230 can employ probabilistic calculus operators including catenation, combination. Additionally or alternatively, a Markovian process and/or Markovian operations can be employed to perform the reduction.

The cycle component 240 is configured to accept graphs, including but not limited to inference graphs 110 and sub-graphs. When modeling complicated causal relationships, cycles will inevitably appear, especially when various authors that are unaware of each other contribute. Additionally, the determination process of hypothetical causal entities often creates cyclical conditions that embed themselves in causality graphs. Cycle component 240 can identify cycles within a graph, and further process the graphs to eliminate cycles, where possible. If cycles are not eliminated throughout a particular graph, then errors within the graph may flow from node to node, perpetuating themselves and spreading the error further throughout the system. In particular, cycle component 240 can detect and correct modeling problems due to scope of granularity. Although cycle component 240 will not fix design flaws from authors, the cycle component 240 can change inference propagation weight to compensate for the aforementioned mistakes. Furthermore, the compensation does not introduce error into the graphs after cycle component 240 processes them.

The cycle component 240 can remove cycles in a variety of ways. The first action is finding the cycles. This can involve locating strongly connected components or nodes in a graph. In particular, the cycle component 240 determines if every single node within the cycle has a path to another node within the cycle. More specifically, a directed graph is strongly connected if for every pair of vertices “u” and “v” there is a path from “u” to “v” and a path from “v” to “u.” A cycle can be removed by applying catenation and/or combination operations between starting and ending nodes of a graph.

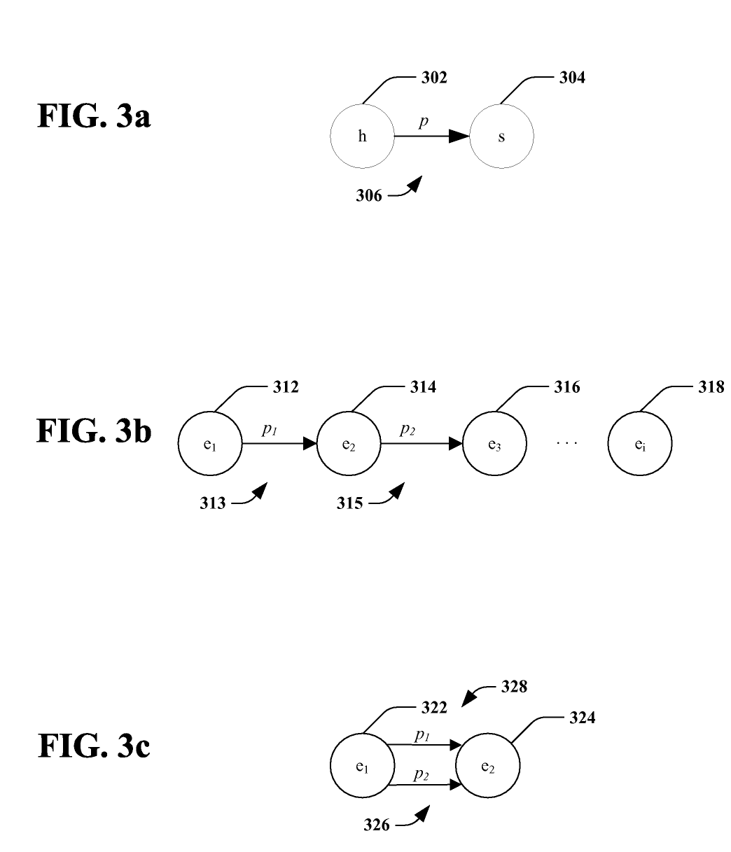

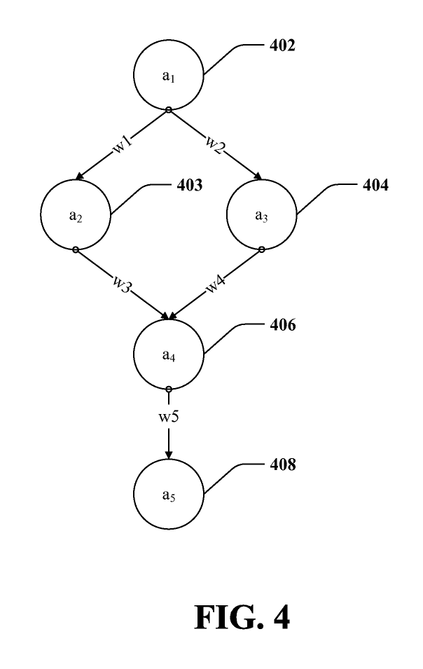

The following describes probability calculus operations that can be employed in optimization of a causality graph in accordance with an aspect of the claimed subject matter. Turning first to FIG. 3a, a simple expression of inference or dependency between two events “h” 302 and “s” 304 is shown. The connection “p” 306 between events “h” 402 and “s” 404 represents a causal relationship between the two. Relationship “p” 306 can represent a probability that “h” 402 is the root cause of “s” 404. FIG. 4a is the simplest example of an inference graph that would be provided as input to a root cause analysis system. Inference graphs in real life situations are often far more complex.

In the event that sequential events are linked together in the manner presented in FIG. 3b, the chain rule would apply, also known as catenation or the catenation operation. Here, a chain of events, “c₁” 312, “c₂” 314, “c₃” 316, and “cᵢ” 318, is occurring. Event “e₁” 312 is causally related to “e₂” 314 through relationship “p₁” 313. Event “e₂” 314 is causally related to “e₃” 316 through relationship “p₂” 315, and so forth. Mathematically:

p₁=P(e₂|e₁), p₂=P(e₃|e₁,e₂) and so forth

P(e₁,e₂,e₃, . . . ,eᵢ)=P(eᵢ|eᵢ₋₁, . . . ,e₂,e₁)* . . . *P(e₂|e₁)*P(e₁)

P(e₁,e₂,e₃, . . . ,eᵢ)=P(eᵢ)*p₁*p₂* . . . Pᵢ₋₁

If “e₁,” which is the hypothesis in causality, then

P(e₁, e₂, e₃, . . . , eᵢ)=p₁*p₂* . . . Pᵢ₋₁

FIG. 3c illustrates an example where multiple relationships may exist between events. As shown, event “e₁” 322 and “e₂” 324 are interrelated by “p₁” 328 and “p₂” 326. The combination operation is used to calculate the probability leading from the first event “e₁” 322 to the last event “e₂” 324. Here, “p1” and “p2are independent events with the following relations:

p Λ q=p*q

˜p+p=1

p1 v p2=˜(p1*˜p2)

FIG. 4 refers to a Markovian parent, and includes a set of realizations “a₁” 402, “a₂” 403, “a₃” 404, “a₄” 406, and “a₅” 408. Conditional probability of an event might not be sensitive to all of its ancestors but only to a small subset of them. That means an event is independent of all other ancestors once we know the value of select groups of its ancestors: “P(ei|ei-1, . . . ,e2,e1)=P(ei|pai)” and therefore “P(e1,e2,e3, . . . ,ei)=πP(ei|pai).”

This reduces the required expert information from specifying the probability of an event, represented as “eᵢ” in above formula, conditional on all realizations of its ancestors “eᵢ₋₁, . . . ,e₂,e₁,” to possible realizations of set “PAi.” Based on the inference graph shown in FIG. 4, propagation from “a₂” 503 to “a₄” 506 and “a₃” 504 to “a₄” 506 could be given by two different experts, therefore “P(a₄|a₂, a₃)” would be unreasonable. Instead, both catenation and combination can be used to calculate “P(a1,a2,a3,a4,a5)”:

P(a1,a2,a3,a4,a5)=P(a1)*(P(a2|a1)*P(a4|a2)+P(a3|a1)*P(a3|a4))*P(a4|a5)

Therefore:

P(a1,a2,a3,a4,a5)=P(a1)*(2*w1*w2*w3*w4−(w1*w2*w3*w4)²)*w5

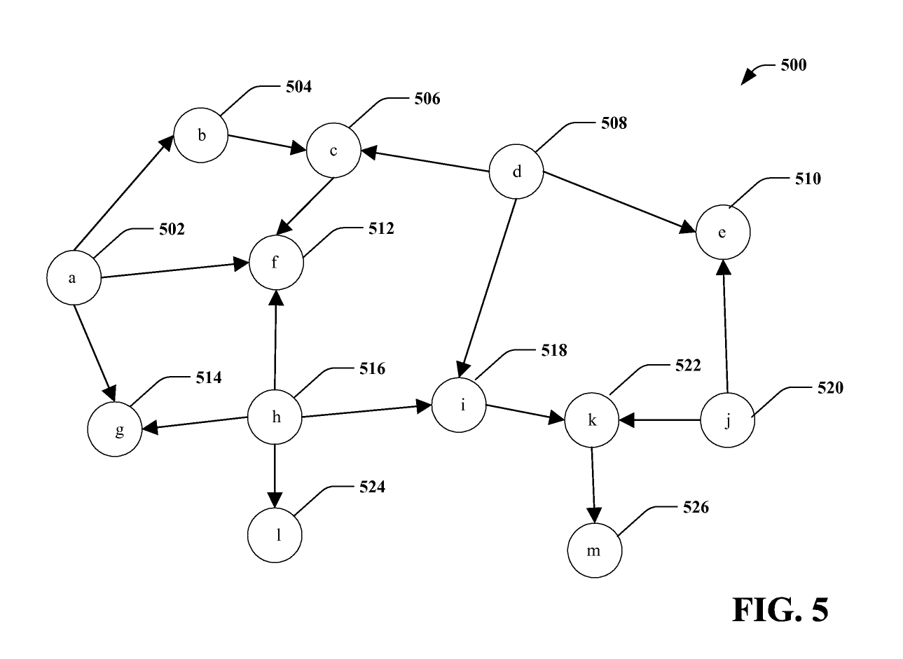

The following figures and description are related to exemplary optimizations that can be performed by the optimization component 130. Turning attention first to FIG. 5, an exemplary inference causality graph 500 is illustrated. Causality graph 500 has not yet been optimized and includes nodes “a” 502, “b” 504, “c” 506, “d” 508, “e” 510, “f” 512, “g” 514, “h” 516, “i” 518, “j” 520, “k” 522, “l” 524, and “m” 526. Note that parent nodes “a” 502, “b” 504, “c” 506, “d” 508, “h” 516, “i” 518, “j” 520, and “k” 522 are causes while child nodes “e” 510, “f” 512, “g” 514, “l” 524, and “m” 526 are the symptoms in this example. If analysis component 120 of FIG. 1 was fed inference or causality graph 500 without further processing root cause analysis would take substantially more iterations to solve, and a high threshold of system resources would be utilized to complete the probable cause analysis. However, division component 220 and/or reduction component 230 of FIG. 2 could accept inference causality graph 500 as an input and provide the analysis component 120 with multiple sub-graphs that would reduce processing iterations.

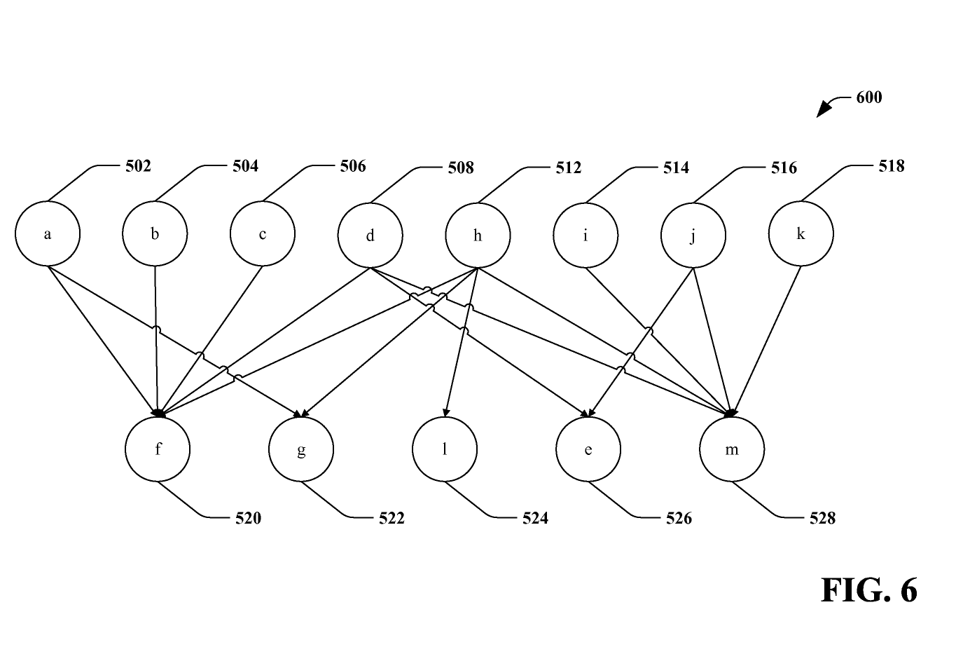

FIG. 6 is an illustration of a bipartite representation 600 of the inference or causality graph derived from the graph in FIG. 5. Note that cause nodes “a” 502, “b” 504, “c” 506, “d” 508, “h” 512, “i” 514, “j” 516, and “k” 518 are distinct from symptom nodes “e” 526, “f” 520, “g” 522, “l” 524, and “m” 528. This is a big improvement. Complexity of propagation is optimized and memory complexity is reduced by eliminating extra edges. However, further optimizations can be applied.

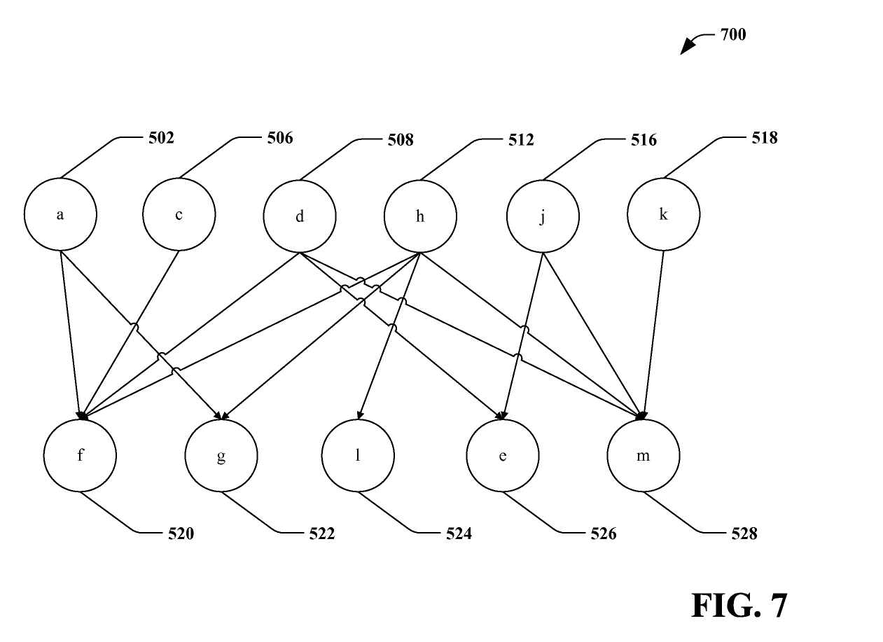

A further reduced bipartite representation 700 is illustrated in FIG. 7. Causes “b” 504 and “i” 514 of representation 600 of FIG. 6 are removed. These particular causes are simply propagating an inference to the next cause or symptom and do not provide extra information to fault identification, as long as they not marked as root causes by an expert. Accordingly, the reduction component 230 can produce representation 700.

Representation 800 is produced by the reduction component 120 as a function of identification of root causes, transient causes, and/or otherwise unnecessary nodes by an expert. In particular, if an expert identifies “a” 502, “d” 508, “h” 512, and “j” 516 as root causes and the remaining nodes as transient, the graph can be reduced to representation 800. Representation 800 does not affect accuracy or false positive ratios, and there still will not be any false negatives when compared to the original causality graph 500 of FIG. 5.

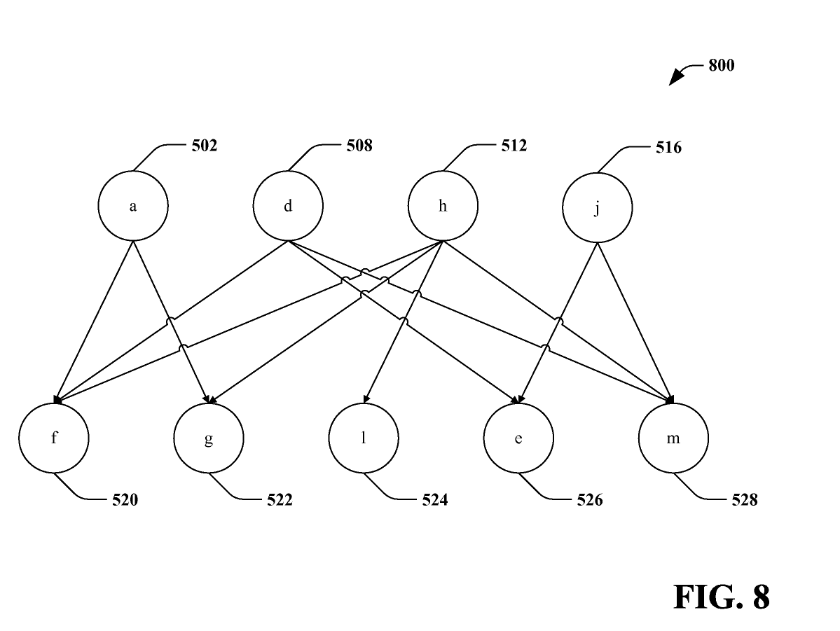

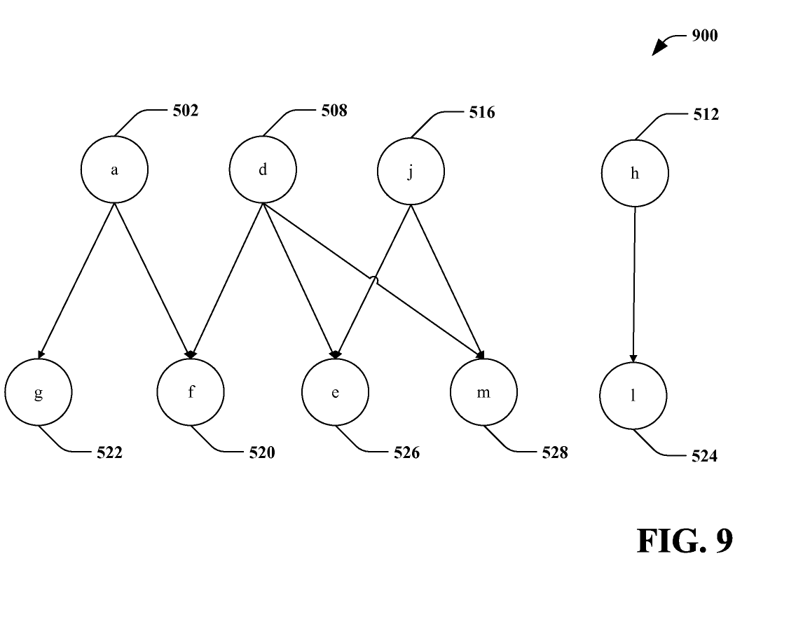

FIG. 9 illustrates an optional embodiment where the inference graph is optimized even further. In order to identify root cause “h” 512, only “l” 524 is required to be monitored. Transitioning from representation 800 of FIG. 8 to representation 900, optimization removed three edges and separated the original inference graph into two disconnected sub-graphs. However, false negative can appear if “l” 524 is lost, because “h” 512 will become unidentifiable.

It is to be noted that the operations performed to produce representations of FIG. 6, FIG. 7, FIG. 8, and FIG. 9 can be executed by the optimization component 130 of FIG. 1. In particular, the reduction component 230 can be employed. Furthermore, the reduction component 230 can perform operations on a plurality of sub-graphs generated by the division component 220.

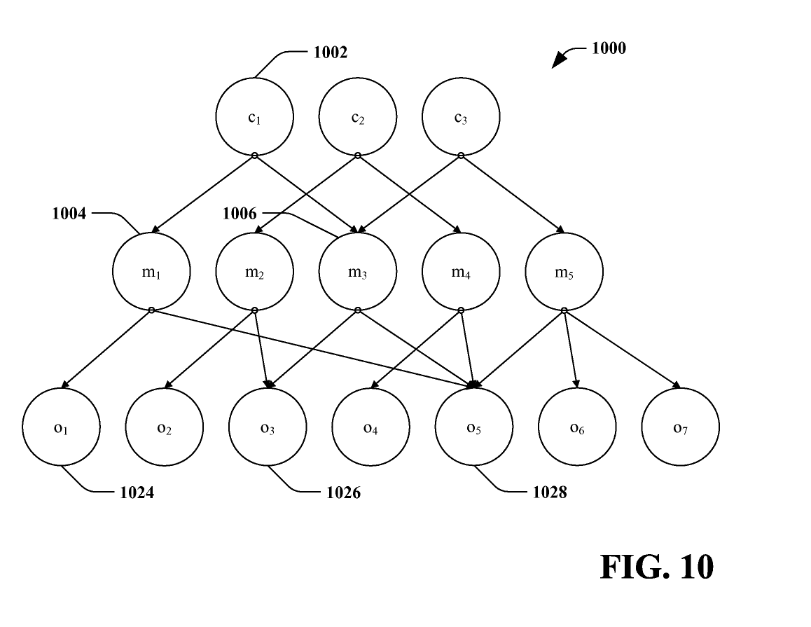

FIG. 10 illustrates a graph 1000 that will undergo Markovian processing, a mechanism for reducing a graph employable by the reduction component 230. Here, root “c₁” 1004 has two children “m₁” 1004 and “m₃” 1006, each of which have two children: (“o₁” 1024 and “o₃” 1026) and (“o₃” 1026 and “o₅” 1028) respectively.

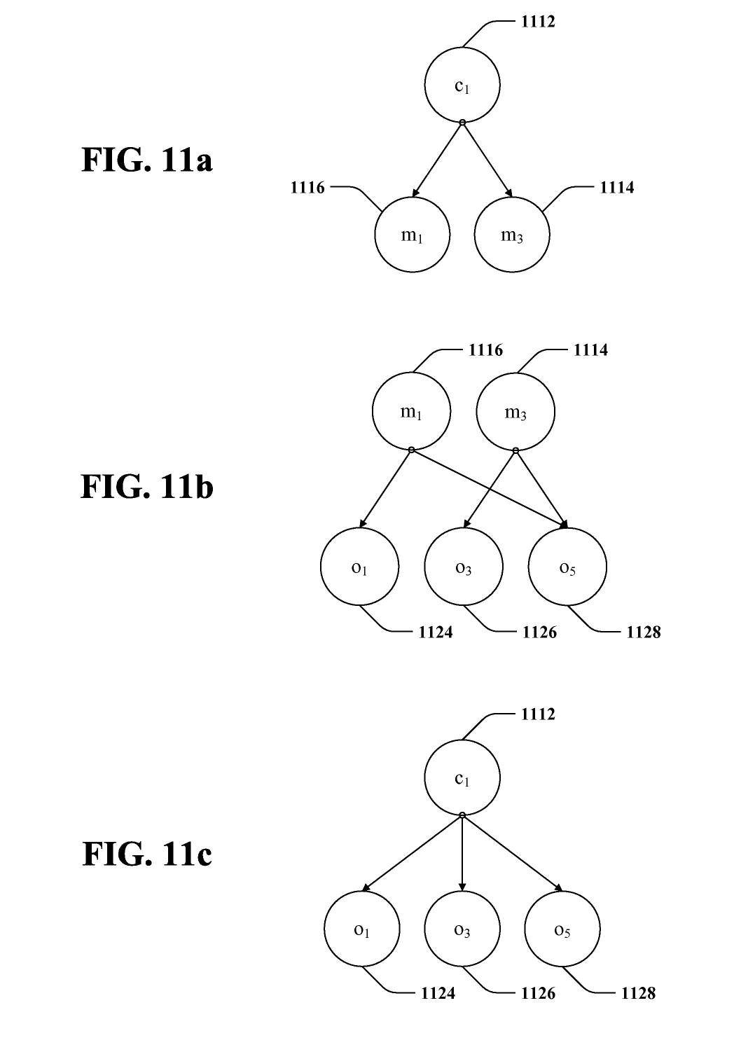

FIG. 11a illustrates breakdown of “c₁” 1112 through “m₁” 1116 and “m₃” 1114 utilizing a catenation operation. FIG. 11b illustrates subsequent action going from “m₁” 1116 and “m₃” 1114 to their connections “o₁” 1124 and “o₃” 1126 and “o₃” 1126 and “o₅” 1128, respectively. These nodes can be processed with catenation operations as well. In particular, from “m₁” to “o₅” and “m₃” to “o₅” edge weights can be recalculated via a catenation operation and the two edges can be reduced to one edge by a combination operation. FIG. 11c illustrates an exemplary simplification after Markovian processing has been completed. Root “c₁” 1112 is mapped directly to symptom nodes “o₁” 1124, “o₃” 1126, and “o₅” 1128. As part of Markovian inference optimization or the like, quantity information can be calculated and stored for each root cause to use it for impact analysis and normalization.

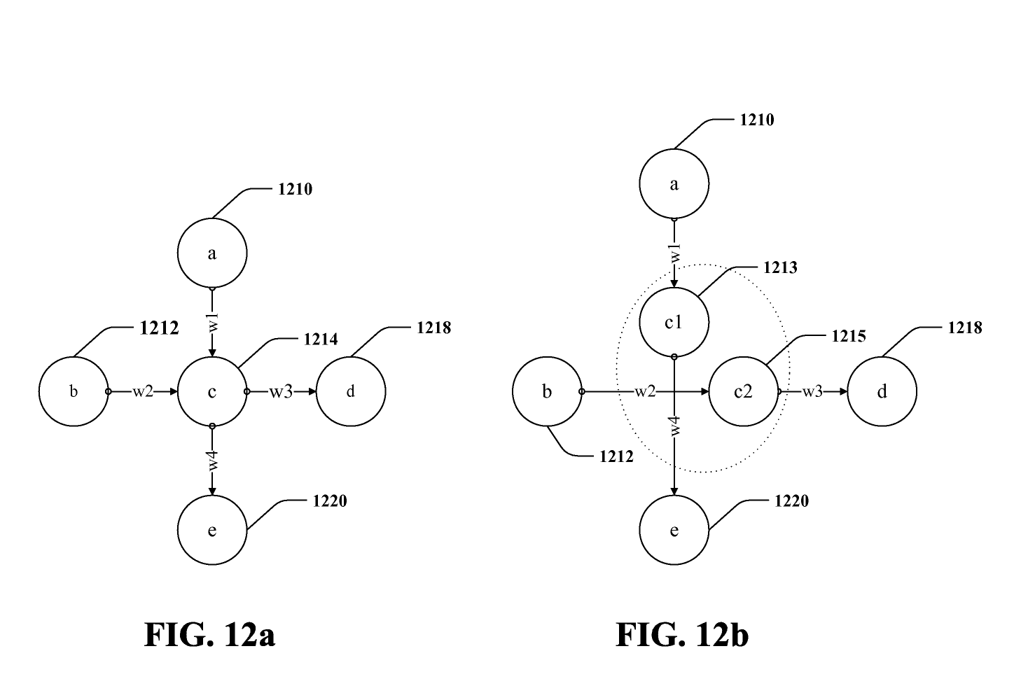

FIGS. 12-14 relate to granularity issues that propagate errors through cycling due to incorrect reasoning. Modeling problems in causality generally have a negative effect on the accuracy of the fault identification process. FIG. 12a exemplifies a graph where “a” 1210 and “b” 1212 are the root causes, while “d” 1218 and “e” 1220 are the symptoms. Node “c” 1214 in FIG. 12a propagates inference from node “a” 1210 to node “e” 1220 and also from node “b” 1212 to node “d” 1218. However, node “c” 1214 was not meant to propagate inference from node “a” 1210 to node “d” 1218 or from node “b” 1212 to node “e” 1220. It should be appreciated that cycle resolution component 240 of FIG. 2 can identify this granularity issue and split node “c” 1214 into “c₁” 1213 and “c₂” 1215, pictured in FIG. 12b. Additionally, the split nodes do not introduce error into the resulting graphs.

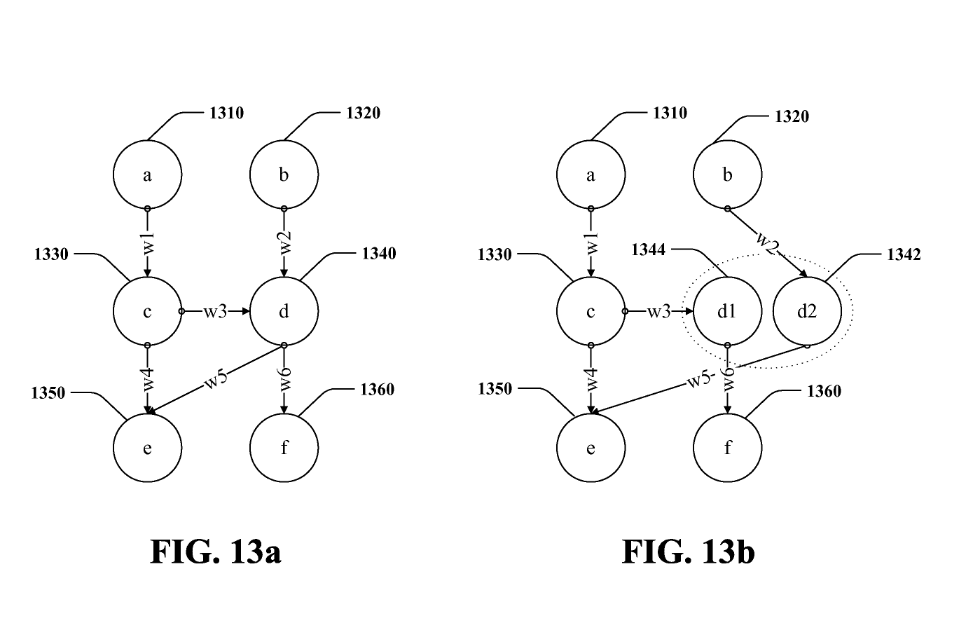

FIG. 13a illustrates another granularity-modeling problem. Here, a graph includes nodes “a” 1310, “b” 1320, “c” 1330, “d” 1340, “e” 1350, and “f” 1360, wherein node “d” 1340 requires remodeling. FIG. 13b shows the remodeling in which “d” 1340 is segmented into “d₁” 1344 and “d₂” 1342. The graph shown in FIG. 13a has a propagation weight from node “a” 1310 to node “e” 1340 calculated to be: “P(a)*w1*(w3*w5+w4−w3*w4*w5).” However, the real causal relationships in the graph of FIG. 13b after recalculation of the propagation weights, from node “a” 1310 to node “e” 1350 is actually different, namely “P(a)*w1*w4.” Thus, the propagation weight has increased: “P(a)*w1*w3*w5*(1−w4).” Further, the optimization does not introduce any negative effects on the result.

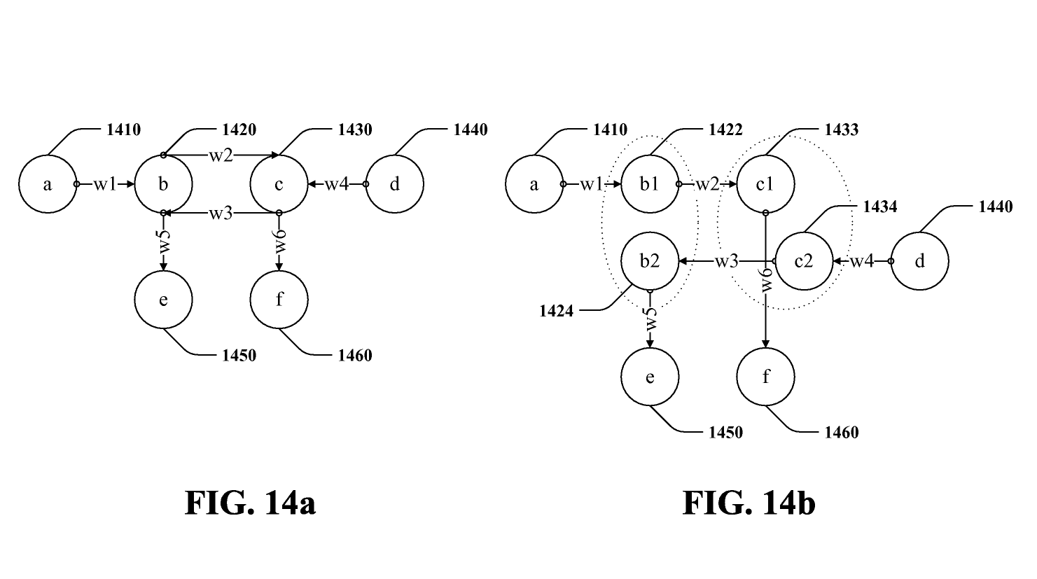

FIG. 14 illustrates a graph with nodes “a” 1410, “b” 1420, “c” 1430, “d” 1440, “e” 1450, and “f” 1460. This illustrates how granularity mistakes can cause cycles in a causality graph. As shown, there is a cycle between nodes “b” 1420 and “c” 1430. Cycles can be removed by correcting granularity mistakes. FIG. 14b depicts how the cycle is removed. In particular, node “b” is split into two nodes “b1” 1422 and “b2” 1424 and node “c” is split into “c1” 1432 and “c2” 1434. This can be accomplished via cycle resolution component 240 of FIG. 2 or more generally optimization component 130 of FIG. 1.

Bayesian inference propagation works on directed acyclic graphs (DAGs). However, cycles are inevitable when modeling complicated causal relationships, especially if modeling is performed by various authors that are unaware of each other. This unawareness between the authors and the complicatedness of causal relationships are not the source of cycles in a causality graph. Rather, the real reason lies in the determination process of hypothetical causal entities. In other words, misidentified hypotheses or granularity mistakes made during determination of hypotheses create conditions of cyclic causality graphs. Complicated causality models or multiple authors make it difficult to see these mistakes.

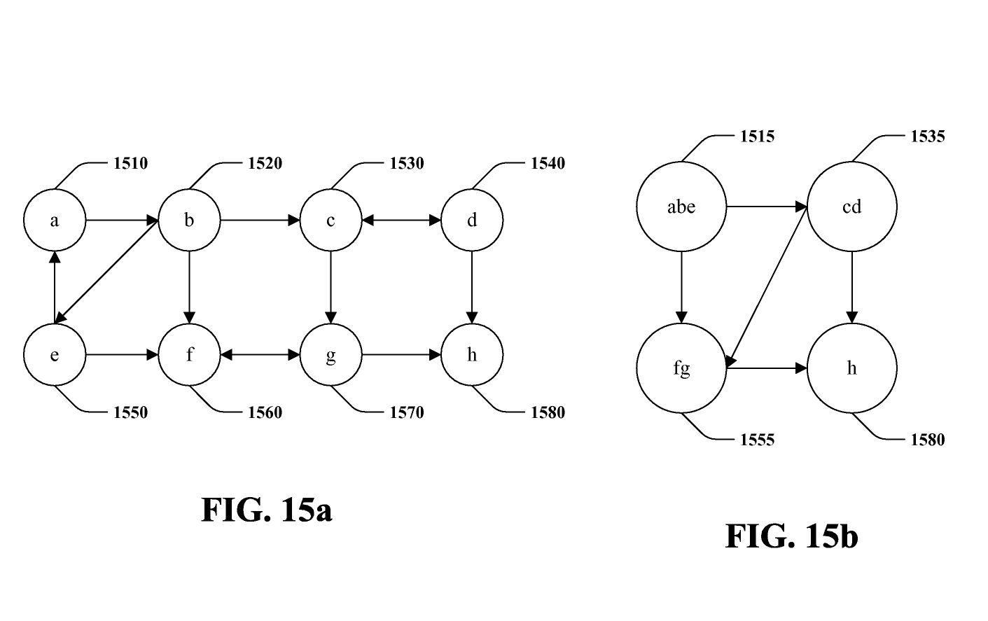

Referring to FIG. 15a, an exemplary inference graph including cycles is depicted. The graph includes nodes “a” 1510, “b” 1520, “c” 1530, “d” 1540, “e” 1550, “f” 1560, “g” 1570, and “h” 1580. A directed graph is called strongly connected if for every pair of vertices “u” and “v” there is a path from “u” to v” and a path from “v” to “u.” The strongly connected components (SCC) of a directed graph are its maximal strongly connected sub-graphs. These form a partition of the graph. Here, “a” 1510, “b” 1520, and “e” 1550 are strongly connected components, which together form a cycle, because there is a connection from “a” 1510 to “b” 1520 and a connection from “b” 1520 to “a” 1510 (e.g., node “b” 1520−>node “e” 1550−>node “a” 1510). All strongly coupled components of the graph shown in 15a are provided in graph 15b. These include three groups of nodes forming cycles including “abc” 1515, “cd” 1535, and “fg” 1555 as well as “h” 1580. It should be appreciated that division component 220 from FIG. 2 or can group the nodes forming cycles into a sub-graphs, as shown in FIG. 15b.

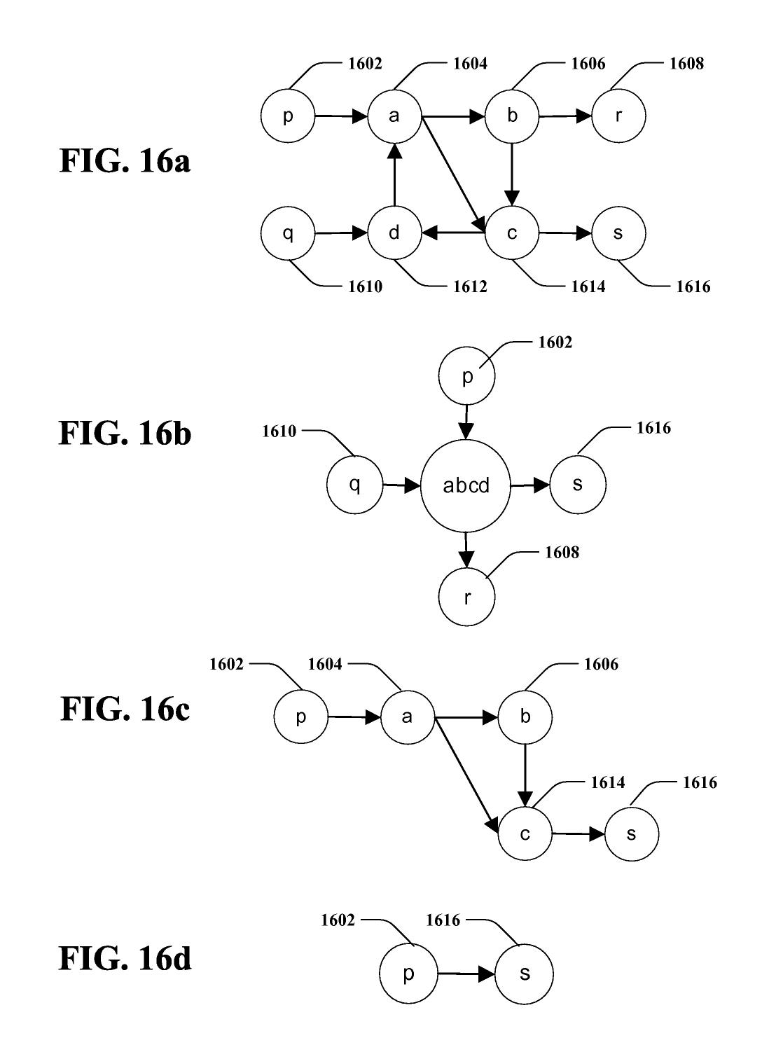

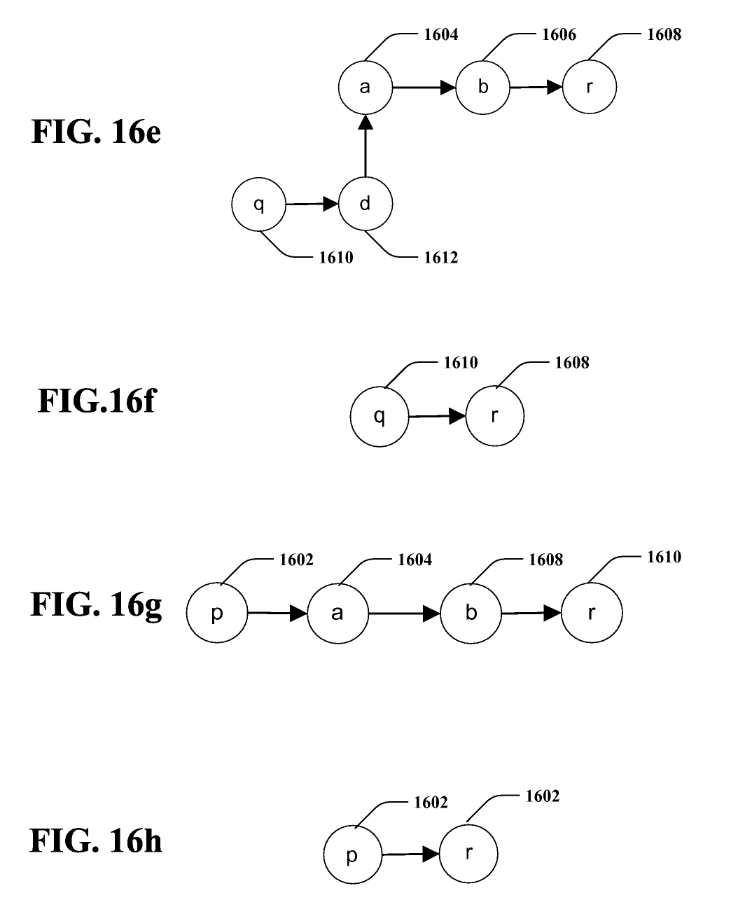

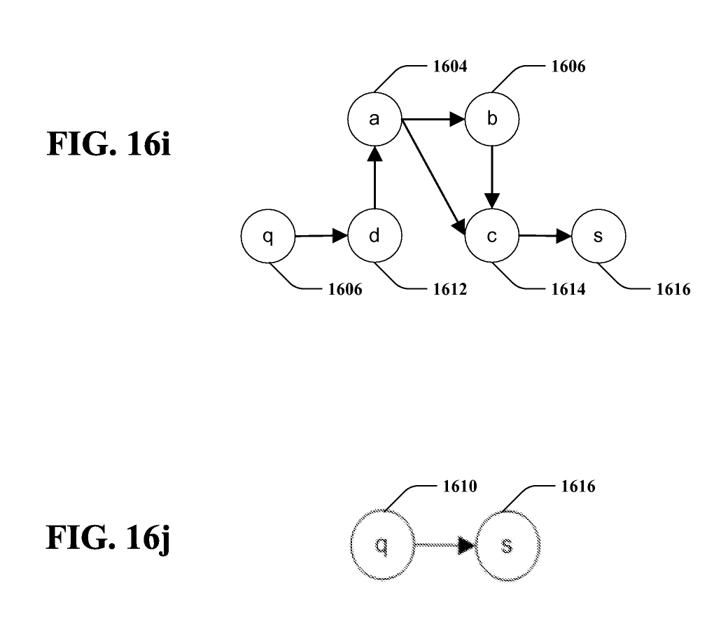

FIGS. 16-19 show optimization of cycles through application of catenation and combination operations between starting and ending nodes. Optimization is done from each start node to each end node: p→r, p→s, q→r, and q→s. For each optimization, a new weight is calculated based on catenation and combination rules.

FIG. 16a is an exemplary graph including cycles. The graph includes nodes “p” 1602, “a” 1604, “b” 1606, “r” 1608, “q” 1610, “d” 1612, “c” 1614, and “s” 1616. Two nodes, “p” 1602 and “q” 1610, point to a cycle formed by nodes “a” 1604, “b” 1606, “c” 1614, and “d” 1612 and the cycle points out to two other nodes, “r” 1608 and “s” 1616 as shown more explicitly in FIG. 16b.

There is not only one optimization for the cycle here. Optimization is performed from each start node to each end node, namely “p−>r,” “p−>s,” “q−>r,” and “q−>s.” FIG. 16c shows the path for “p−>s” In the end of the optimization, will be “p−>s” with new weight calculated using catenation and combination rules as shown in FIG. 16d. The path “q−>r” is shown in FIG. 16e, which can be, optimized to simply “q−>r” with new weight calculated utilizing catenation and combination rules as shown in FIG. 16f. Similarly, the paths for “p−>r” and “q−>s” are provided in FIGS. 16g and 16h respectively. Both reduce to a single edge with weight computed using catenation and combination rules to produce “p−>r” for path “p−>r” as shown in FIG. 16i and “q−>s” for path “q−>s” illustrated in FIG. 16j.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the optimization component 130 can employ such mechanism in optimizing a causality or inference graph. For instance, based on context information such as available processing power, the optimization component 130 can infer perform optimization as a function thereof.

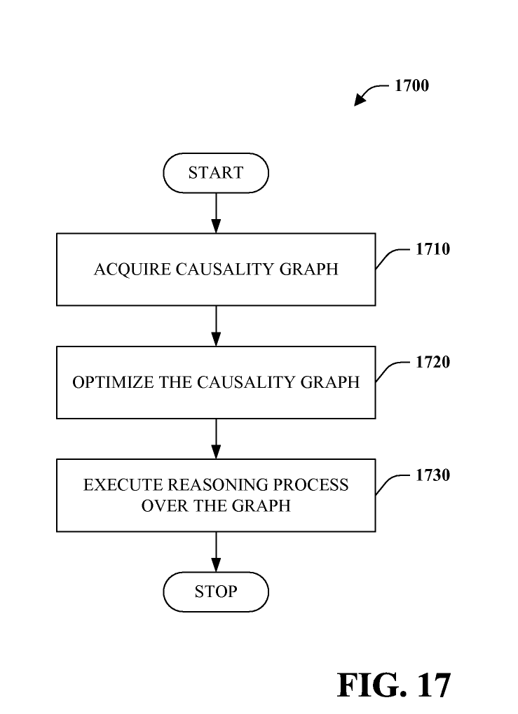

In view of the exemplary systems described supra, methodologies that may be implemented in accordance with the disclosed subject matter will be better appreciated with reference to the flow chart presented in FIGS. 17-20. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 17 is a flow chart diagram of a method of optimizing root cause analysis 1700 in accordance with an aspect of the disclosure. At reference numeral 1710, an input causality or inference graph is acquired. Typically, an inference graph is a directed graph comprised of multiple nodes, each of which represents an observation, a root cause, or a meta-node. Nodes within the inference graph are linked by paths that represent a causality relationship, in a manner such that state of a child node is dependent on state of a parent node. This causality graph is optimized at reference numeral 1720. Numerous individual and combinations of optimization techniques can be employed. For example, the graph can be reduced in size well maintaining captured information by eliminate unnecessary nodes. At reference numeral 1730, analysis or reasoning is performed over the optimized causality graph. Accordingly, root cause analysis can be improved by optimally augmenting the causality graph utilized by a reasoning algorithm or the like to identify root causes as a function of symptoms and/or observations. Of course, the reasoning algorithm can also be optimized to improve performance such as by leveraging an optimized causality graph.

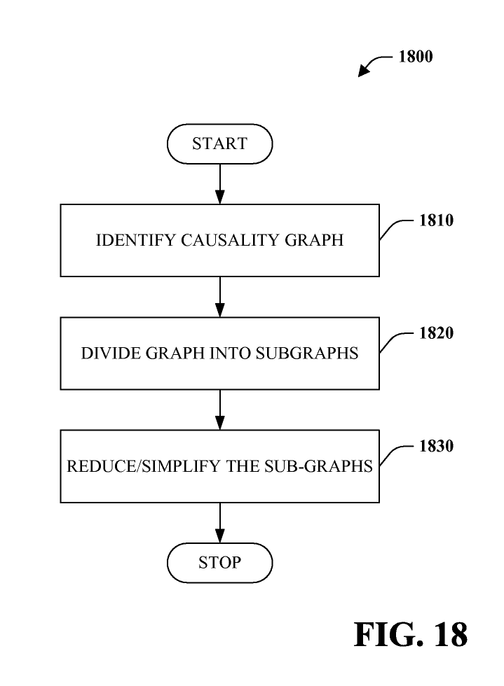

FIG. 18 illustrates a method of optimizing a causality graph 1800 in accordance with an aspect of the claimed subject matter. At reference numeral 1810, a causality graph such as an inference graph can be received, retrieved, or otherwise obtained or acquired. At numeral 1820, the graph is divided into a plurality of sub-graphs. This can enable root cause reasoning to be performed much faster since operations can be performed on smaller sets of data and multiple processor computing architectures and/or multiple computers can be employed for each sub-graph. At reference numeral 1830, each sub-graph can be reduced in complexity or simplified while maintaining captured information, thereby easing the work required with respect to reasoning over such a graph. In most cases, accuracy of the root cause analysis and false positive ratio can be preserved after reduction/optimization. Thus, optimization of a graph does not have to reduce the quality or value of the graph as an input to root cause analysis. In accordance with one aspect, sub-graphs can be reduced to bipartite graphs including causes and symptoms or observations. However, multi-level graphs may result. Reduction can be performed utilizing a plurality of probability calculus operations such as catenation and combination and/or a Markovian process, among other things.

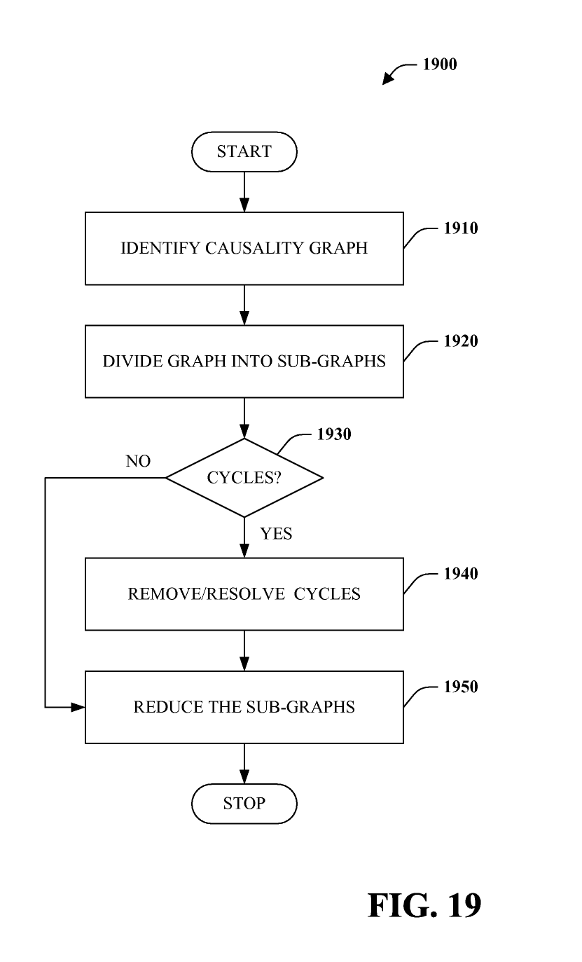

FIG. 19 illustrates a method of optimizing a causality graph 1900 in accordance with an aspect of the claimed subject matter. At numeral 1910, a causality or inference graph is identified. As previously described, such a graph can include numerous nodes of various types such as cause nodes, observation nodes and meta-nodes, wherein nodes are linked by paths that define dependency relationships. At numeral 1920, the identified graph is broken up into sub-graphs to facilitate processing across multiple processors and/or computers. For example, a graph can be analyzed to identify weakly connected components for use as a basis of division.

At reference 1930, a determination is made as to whether any cycles exist in the causality graph or more specifically each sub-graph. The presence of cycles in a graph is indicative of granularity errors in modeling, which can occurs as result of graph size and/or complexity as well as multiple author generation. To locate cycles, strongly connected components of directed graphs can be identified, for instance. If cycles are identified at 1930, they are resolved or removed, if possible at numeral 1940. Cycle resolution can purge unwanted feedback in a system that would otherwise create noise or interference that could contribute to the root cause analysis problems. As with other optimization techniques, cycle resolution can involve utilizing catenation and/or combination operation to reduce or otherwise reconstruct portions of a graph while preserving nodal relationships and/or overall knowledge captured by the graph.

Following act 1940 or upon failure to detect any cycles, the method can precede to reference numeral 1950, where the sub-graphs are reduced or simplified as much as possible, for example into a bipartite representation of causes and observations to graph size and complexity to facilitate computation of root cause based thereon. This can be achieved by removing excess nodes or edges, simplifying the inference graph utilizing probability calculus catenation, combination, and/or Markovian operations, among other things.

It is to be noted that various action of method 1900 can be combined or executed together. For example, cycles can be detected, when present, and resolved in the context of a graph reduction action. In other words, while a graph is being reduced into a bipartite representation, for example, if a cycle is detected the reduction process proceeds with a separate branch to resolve the cycle prior to proceeding with reduction.

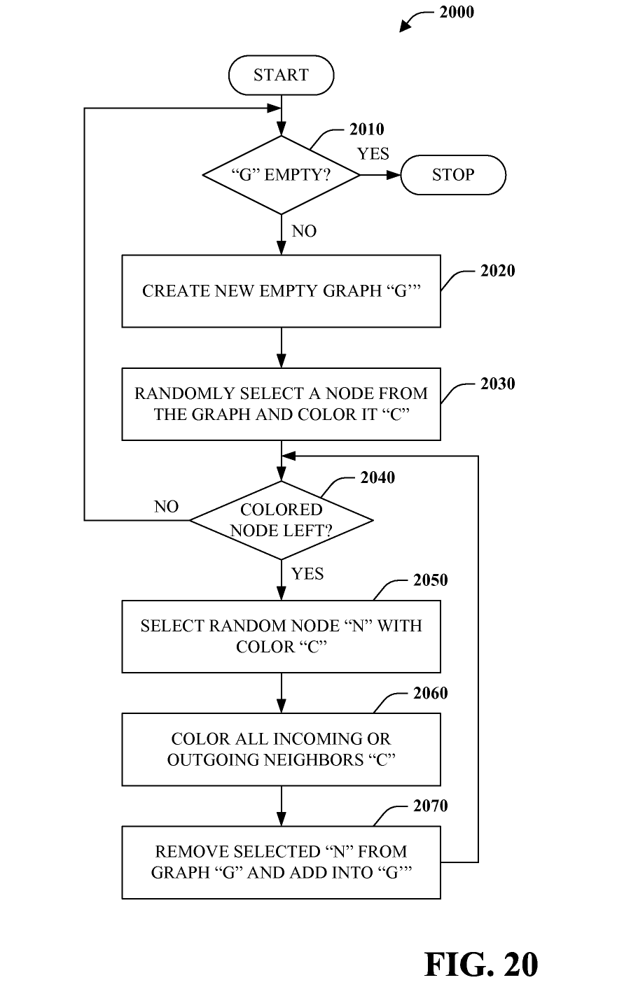

Turning attention to FIG. 20, a method of identifying weakly connected graph components 2000 is depicted in accordance with an aspect of the claimed subject matter. Among other things, the method can be employed in conjunction with graph division into sub-graphs, as a basis therefor. At reference numeral 2010, a determination is made as to whether the main input graph under process is empty. This provides a termination mechanism as “G” should be either full or empty. If at 2010, the main graph “G” is empty, the method can terminate. Alternatively, the method continues at numeral 2020 where a new empty graph “G′” is created. A node can be randomly selected from the main graph “G” and colored or otherwise associated with “C” at numeral 2030. At reference 2040, a determination is made concerning whether a colored node is left in the main graph “G.” If there are not any colored nodes left, the method proceeds back to reference 2010. Alternatively, the method continues at 2050 where a random or pseudo-random node “N” with a specific color “C” is selected. All incoming and outgoing neighbors of “N” are colored with the same color “C” at reference 2060. The randomly selected node “N” is removed from the main graph “G” and put into new graph “G′” at numeral 2070. This can be accomplished by keeping edges still pointing to the node “N” previously colored with “C” but this time in the new graph “G′.” The method then proceeds to loop back to reference numeral 2040 where a check is made as to whether any colored nodes are left.

In furtherance of clarity and understanding, the following is pseudo-code for implementation of method 2000:
Loop until the main graph G is empty
   Create a new empty graph G′
   Randomly select a node from the graph and color it with C
   Loop until there is not any colored node left
      Select a random node N with color C.
      Color all its incoming or outgoing neighbors with C
      Remove the selected node N and from the graph G and put it into G′ by keeping edges still pointing to the node N previously colored with C but this time in graph G′
   End loop
End loop

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

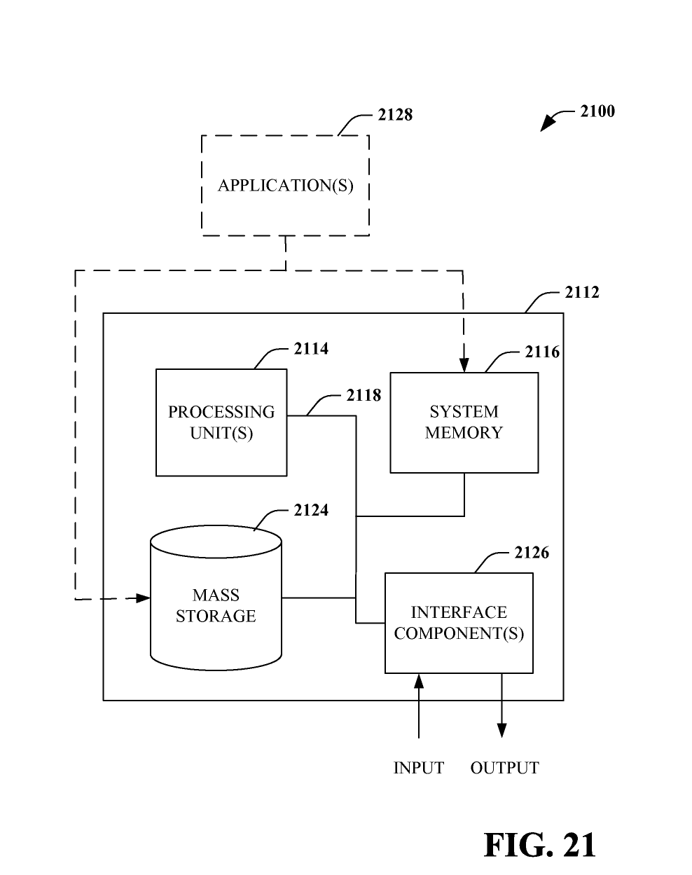

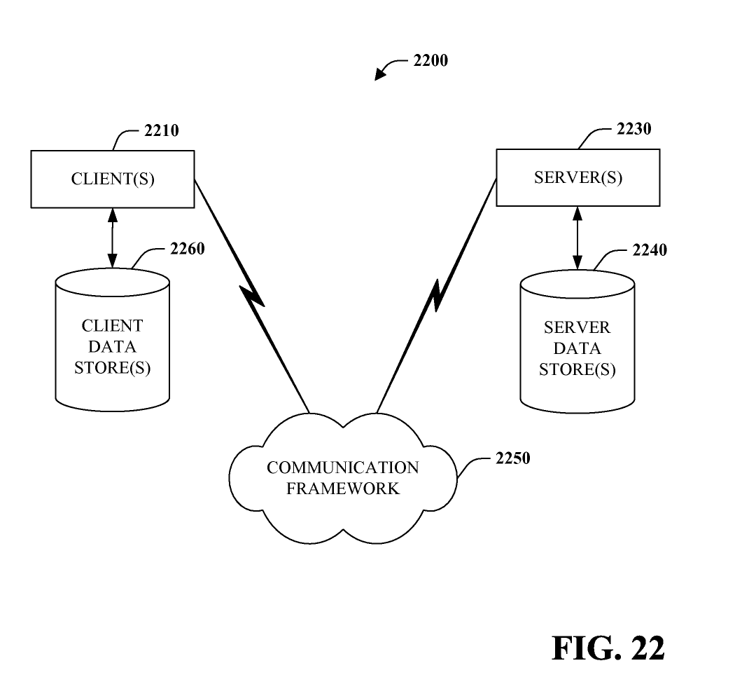

In order to provide a context for the various aspects of the disclosed subject matter, FIGS. 21 and 22 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 21, an exemplary environment 2100 for implementing various aspects disclosed herein includes an application 2128 and a processor 2112 (e.g., desktop, laptop, server, hand held, programmable consumer, industrial electronics, and so forth). The processor 2112 includes a processing unit 2114, a system memory 2116, and a system bus 2118. The system bus 2118 couples system components including, but not limited to, the system memory 2116 to the processing unit 2114. The processing unit 2114 can be any of various available microprocessors. It is to be appreciated that dual microprocessors, multi-core and other multiprocessor architectures can be employed as the processing unit 2114.

The system memory 2116 includes volatile and nonvolatile memory. The basic input/output system (BIOS), containing the basic routines to transfer information between elements within the computer 2112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Processor 2112 also includes removable/non-removable, volatile/non-volatile computer storage media. FIG. 21 further illustrates, for example, mass storage 2124. Mass storage 2124 includes, but is not limited to, devices like a magnetic or optical disk drive, floppy disk drive, flash memory, or memory stick. In addition, mass storage 2124 can include storage media separately or in combination with other storage media.

Additionally, FIG. 21 provides software application(s) 2128 that acts as an intermediary between users and/or other computers and the basic computer resources described in suitable operating environment 2100. Such software application(s) 2128 include one or both of system and application software. System software can include an operating system, which can be stored on mass storage 2124, that acts to control and allocate resources of the processor 2112. Application software takes advantage of the management of resources by system software through program modules and data stored on either or both of system memory 2126 and mass storage 2124.

The processor 2112 also includes one or more interface components 2126 that are communicatively coupled to the bus 2118 and facilitate interaction with the processor 2112. By way of example, the interface component 2126 can be a port (e.g., serial, parallel, PCMCIA, USB, FireWire . . . ) or an interface card (e.g., sound, video, network . . . ) or the like. The interface component 2126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the processor 2112 to output device(s) via interface component 2126. Output devices can include displays (e.g., CRT, LCD, plasma . . . ), speakers, printers, and other computers, among other thing.

FIG. 22 is a schematic block diagram of a sample-computing environment 2200 with which the subject innovation can interact. The system 2200 includes one or more client(s) 2210. The client(s) 2210 can be hardware and/or software (e.g., threads, processes, computing devices). The system 2200 also includes one or more server(s) 2230. Thus, system 2200 can correspond to a two-tier client server model or a multi-tier model (e.g., client, middle tier server, data server), amongst other models. The server(s) 2230 can also be hardware and/or software (e.g., threads, processes, computing devices). The servers 2230 can house threads to perform transformations by employing the aspects of the subject innovation, for example. One possible communication between a client 2210 and a server 2230 may be in the form of a data packet transmitted between two or more computer processes.

The system 2200 includes a communication framework 2250 that can be employed to facilitate communications between the client(s) 2210 and the server(s) 2230. The client(s) 2210 are operatively connected to one or more client data store(s) 2260 that can be employed to store information local to the client(s) 2210. Similarly, the server(s) 2230 are operatively connected to one or more server data store(s) 2240 that can be employed to store information local to the servers 2230.

Client/server interactions can be utilized with respect with respect to various aspects of the claimed subject matter. By way of example and not limitation, one or more components and/or method actions can be embodied as network or web services afforded by one or more servers 2230 to one or more clients 2210 across the communication framework 2250. For instance, the optimization component 130 can be embodied as a web service that accepts causality graphs and returns optimized versions thereof.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. An optimized root cause analysis system, comprising:
a division component that divides a causality graph into sub-graphs; and
a reduction component that reduces at least one of the sub-graphs to a bipartite graph of causes and observations.

2. The system of claim 1, the division component identifies weakly connected sub-graphs from the causality graph.

3. The system of claim 1, the reduction component further reduces at least one of the sub-graphs as a function of expert information regarding root and/or transient causes.

4. The system of claim 1, the reduction component employs a Markovian processes to reduce the complexity of sub-graphs.

5. The system of claim 1, the reduction component employs a one or more probability calculus operations including catenation or combination.

6. The system of claim 1, further comprising a cycle resolution component that identifies and removes cycles from the sub-graphs.

7. The system of claim 6, the cycle resolution component applies probability calculus operations catenation and/or combination between starting and ending nodes.

8. The system of claim 1, further comprising an analysis component that reasons over the bipartite graphs to identify root causes.

9. A method optimizing root cause analysis, comprising:
identifying a causality graph; and
reducing the graph to a bipartite graph of causes and symptoms.

10. The method of claim 9, further comprising employing probability calculus to reduce the graph.

11. The method of claim 9, further comprising executing a Markovian process to reduce the graph.

12. The method of claim 9, comprising reducing the graph further as function of expert identified root causes and/or transient causes.

13. The method of claim 9, further comprising partitioning the graph into sub-graphs to facilitate parallel processing.

14. The method of claim 13, further comprising identifying weakly connected sub-graphs and partitioning as a function thereof.

15. The method of claim 9, further comprising detecting and removing cycles.

16. The method of claim 15, removing cycles comprising applying catenation and combination operations between starting and ending nodes in a graph.

17. A root cause analysis optimization method, comprising:
segmenting an inference graph into multiple sub-graphs;
removing cycles from the sub-graphs; and
reducing the complexity of at least one of the sub-graphs.

18. The method of claim 17, further comprising reducing at least one of the sub-graphs to a bipartite graph of causes and observations.

19. The method of claim 18, further comprising reducing bipartite graphs as a function of expert information about root and/or transient causes.

20. The method of claim 17, further comprising reasoning over at least one of sub-graphs to identify root causes given one or more observations.
